(19) United States
(12) Patent Application Publication
(10) Pub. No.: US 2026/0082398 A1
(43) Pub. Date: Mar. 19, 2026

(54) WIDEBAND SIDELINK SYNCHRONIZATION SIGNAL BLOCK

(71) Applicant: QUALCOMM INCORPORATED, San Diego, CA (US)

(72) Inventors: Chih-Hao LIU, San Diego, CA (US); Jae Ho RYU, San Diego, CA (US); Jing SUN, San Diego, CA (US); Xiaoxia ZHANG, San Diego, CA (US); Chu-Hsiang HUANG, San Diego, CA (US); Stelios STEFANATOS, San Diego, CA (US); Giovanni CHISCI, San Diego, CA (US)

(21) Appl. No.: 19/102,370

(22) PCT Filed: Oct. 5, 2023
(86) PCT No.: PCT/US2023/076133

§ 371 Date: Feb. 7, 2025

(30) Foreign Application Priority Data
Nov. 3, 2022 (GR) 20220100896

(51) Int. Cl. H04W 72/25; H04W 72/0453

(52) U.S. Cl. CPC H04W 72/25; H04W 72/0453

(57) ABSTRACT

Methods, systems, and devices for wireless communications are described. A user equipment (UE) may generate a first portion of a sidelink control message that may include a primary synchronization signal and a secondary′ synchronization signal occupying a first subset of a bandwidth of the sidelink control message. The UE may generate a second portion of the sidelink control message to occupy a second subset of the bandwidth of the sidelink control message such that the bandwidth satisfies an occupied channel bandwidth threshold. The second portion of the sidelink control message may include additional control information or additional data information that is encoded such that the first portion is decodable independent of a successful decoding of the second portion. The UE may 7 transmit the sidelink control message to a second UE.

### CROSS REFERENCES

The present Application is a 371 national stage filing of International PCT Application No. PCT/US2023/076133 by LIU et al. entitled “WIDEBAND SIDELINK SYNCHRONIZATION SIGNAL BLOCK,” filed Oct. 5, 2023; and claims priority to Greek Patent Application No. 20220100896 by LIU et al. entitled “WIDEBAND SIDELINK SYNCHRONIZATION SIGNAL BLOCK,” filed Nov. 3, 2022, each of which is assigned to the assignee hereof, and each of which is expressly incorporated by reference in its entirety herein.

### FIELD OF TECHNOLOGY

The following relates to wireless communications, including wideband sidelink synchronization signal block.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may transmit a sidelink synchronization block. However, such approaches may be improved.

### SUMMARY

The described techniques relate to improved methods, systems, devices, and apparatuses that support the use of a wideband sidelink synchronization signal block. A user equipment (UE) may generate a first portion of a sidelink control message that may include a primary synchronization signal and a secondary synchronization signal occupying a first subset of a bandwidth of the sidelink control message. The UE may generate a second portion of the sidelink control message to occupy a second subset of the bandwidth of the sidelink control message such that the bandwidth satisfies an occupied channel bandwidth threshold. The second portion of the sidelink control message may include additional control information or additional data information that is encoded such that the first portion is decodable independent of a successful decoding of the second portion. The UE may transmit the sidelink control message to a second UE.

A method for wireless communications at a first user equipment (UE) is described. The method may include generating a first portion of a sidelink control message, where the first portion of the sidelink control message includes a primary synchronization signal and a secondary synchronization signal occupying a first subset of a bandwidth of the sidelink control message, generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion, and transmitting the sidelink control message to a second UE.

An apparatus for wireless communications at a first UE is described. The apparatus may include a processor, memory coupled with the processor, and instructions stored in the memory. The instructions may be executable by the processor to cause the apparatus to generate a first portion of a sidelink control message, where the first portion of the sidelink control message includes a primary synchronization signal and a secondary synchronization signal occupying a first subset of a bandwidth of the sidelink control message, generate a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion, and transmit the sidelink control message to a second UE.

Another apparatus for wireless communications at a first UE is described. The apparatus may include means for generating a first portion of a sidelink control message, where the first portion of the sidelink control message includes a primary synchronization signal and a secondary synchronization signal occupying a first subset of a bandwidth of the sidelink control message, means for generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion, and means for transmitting the sidelink control message to a second UE.

A non-transitory computer-readable medium storing code for wireless communications at a first UE is described. The code may include instructions executable by a processor to generate a first portion of a sidelink control message, where the first portion of the sidelink control message includes a primary synchronization signal and a secondary synchronization signal occupying a first subset of a bandwidth of the sidelink control message, generate a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion, and transmit the sidelink control message to a second UE.

In some examples of the method, apparatuses, and non-transitory computer-readable medium described herein, the additional control information or additional data information included in the second portion of the sidelink control message may be rate-matched to occupy the second subset of the bandwidth of the sidelink control message.

In some examples of the method, apparatuses, and non-transitory computer-readable medium described herein, the additional control information or additional data information may be rate-matched based on rate-matched control information included in the first portion of the sidelink control message.

In some examples of the method, apparatuses, and non-transitory computer-readable medium described herein, the additional control information or additional data information may be rate-matched beginning with a lowest frequency resource of the second portion and a first time resource of the second portion of the sidelink control message.

In some examples of the method, apparatuses, and non-transitory computer-readable medium described herein, the additional control information or additional data information may be rate-matched independently from rate-matched control information included in the first portion of the sidelink control message.

In some examples of the method, apparatuses, and non-transitory computer-readable medium described herein, the second portion of the sidelink control message includes frequency domain repetitions of the additional control information or additional data information.

In some examples of the method, apparatuses, and non-transitory computer-readable medium described herein, the frequency domain repetitions may be rate-matched to occupy time resources corresponding to symbols of the primary synchronization signal and the secondary synchronization signal.

In some examples of the method, apparatuses, and non-transitory computer-readable medium described herein, the frequency domain repetitions may be rate-matched from a first symbol to a last symbol or in accordance with a rate-matching order of control information included in the first portion of the sidelink control message.

In some examples of the method, apparatuses, and non-transitory computer-readable medium described herein, each demodulation reference signal associated with a respective frequency domain repetition may be based on different initialization values.

In some examples of the method, apparatuses, and non-transitory computer-readable medium described herein, the additional control information includes sidelink broadcast channel signaling rate-matched in accordance with a first rate-matching pattern and one or more demodulation reference signals rate-matched in accordance with a second rate-matching pattern different than the first rate-matching pattern.

In some examples of the method, apparatuses, and non-transitory computer-readable medium described herein, the additional control information includes sidelink control channel signaling, the additional data information includes sidelink shared channel signaling, or both.

In some examples of the method, apparatuses, and non-transitory computer-readable medium described herein, the sidelink control message may be associated with a quantity of synchronization rasters and the first portion of the sidelink control message and the second portion of the sidelink control message may be generated in accordance with a frequency resource allocation pattern that may be based on the quantity of synchronization rasters and one or more frequency domain locations of the quantity of synchronization rasters.

In some examples of the method, apparatuses, and non-transitory computer-readable medium described herein, the frequency resource allocation pattern may be based on a resource block offset associated with the first portion of the sidelink control message and a bandwidth of the second portion of the sidelink control message.

In some examples of the method, apparatuses, and non-transitory computer-readable medium described herein, the frequency resource allocation pattern may be based on a quantity of resource blocks associated with the first portion of the sidelink control message, one or more gaps between the resource blocks, a block index associated with the first portion of the sidelink control message, or any combination thereof.

In some examples of the method, apparatuses, and non-transitory computer-readable medium described herein, the frequency resource allocation pattern may be associated with a demodulation reference signal sequence associated with the first portion of the sidelink control message, a demodulation reference signal comb index, or both.

In some examples of the method, apparatuses, and non-transitory computer-readable medium described herein, the additional control information includes sidelink broadcast channel signaling.

A method for wireless communications at a second UE is described. The method may include decoding a first portion of a sidelink control message, the first portion of the sidelink control message including a primary synchronization signal and a secondary synchronization signal that occupy a first subset of a bandwidth of the sidelink control message and where the sidelink control message further includes a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

An apparatus for wireless communications at a second UE is described. The apparatus may include a processor, memory coupled with the processor, and instructions stored in the memory. The instructions may be executable by the processor to cause the apparatus to decode a first portion of a sidelink control message, the first portion of the sidelink control message including a primary synchronization signal and a secondary synchronization signal that occupy a first subset of a bandwidth of the sidelink control message and where the sidelink control message further include a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

Another apparatus for wireless communications at a second UE is described. The apparatus may include means for decoding a first portion of a sidelink control message, the first portion of the sidelink control message including a primary synchronization signal and a secondary synchronization signal that occupy a first subset of a bandwidth of the sidelink control message and means for where the sidelink control message further includes a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

A non-transitory computer-readable medium storing code for wireless communications at a second UE is described. The code may include instructions executable by a processor to decode a first portion of a sidelink control message, the first portion of the sidelink control message including a primary synchronization signal and a secondary synchronization signal that occupy a first subset of a bandwidth of the sidelink control message and where the sidelink control message further include a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

In some examples of the method, apparatuses, and non-transitory computer-readable medium described herein, the additional control information or additional data information included in the second portion of the sidelink control message may be rate-matched to occupy the second subset of the bandwidth of the sidelink control message.

In some examples of the method, apparatuses, and non-transitory computer-readable medium described herein, the additional control information or additional data information may be rate-matched based on rate-matched control information included in the first portion of the sidelink control message.

In some examples of the method, apparatuses, and non-transitory computer-readable medium described herein, the additional control information or additional data information may be rate-matched beginning with a lowest frequency resource of the second portion and a first time resource of the second portion of the sidelink control message.

In some examples of the method, apparatuses, and non-transitory computer-readable medium described herein, the additional control information or additional data information may be rate-matched independently from rate-matched control information included in the first portion of the sidelink control message.

In some examples of the method, apparatuses, and non-transitory computer-readable medium described herein, the second portion of the sidelink control message includes frequency domain repetitions of the additional control information or additional data information.

In some examples of the method, apparatuses, and non-transitory computer-readable medium described herein, the frequency domain repetitions may be rate-matched to occupy time resources corresponding to symbols of the primary synchronization signal and the secondary synchronization signal.

In some examples of the method, apparatuses, and non-transitory computer-readable medium described herein, the frequency domain repetitions may be rate-matched from a first symbol to a last symbol or in accordance with a rate-matching order of control information included in the first portion of the sidelink control message.

In some examples of the method, apparatuses, and non-transitory computer-readable medium described herein, each demodulation reference signal associated with a respective frequency domain repetition may be based on different initialization values.

In some examples of the method, apparatuses, and non-transitory computer-readable medium described herein, the additional control information includes sidelink broadcast channel signaling rate-matched in accordance with a first rate-matching pattern and one or more demodulation reference signals rate-matched in accordance with a second rate-matching pattern different than the first rate-matching pattern.

In some examples of the method, apparatuses, and non-transitory computer-readable medium described herein, the additional control information includes sidelink control channel signaling, the additional data information includes sidelink shared channel signaling, or both.

In some examples of the method, apparatuses, and non-transitory computer-readable medium described herein, the sidelink control message may be associated with a quantity of synchronization rasters and the first portion of the sidelink control message and the second portion of the sidelink control message may be generated in accordance with a frequency resource allocation pattern that may be based on the quantity of synchronization rasters and one or more frequency domain locations of the quantity of synchronization rasters.

In some examples of the method, apparatuses, and non-transitory computer-readable medium described herein, the frequency resource allocation pattern may be based on a resource block offset associated with the first portion of the sidelink control message and a bandwidth of the second portion of the sidelink control message.

In some examples of the method, apparatuses, and non-transitory computer-readable medium described herein, the frequency resource allocation pattern may be based on a quantity of resource blocks associated with the first portion of the sidelink control message, one or more gaps between the resource blocks, a block index associated with the first portion of the sidelink control message, or any combination thereof.

In some examples of the method, apparatuses, and non-transitory computer-readable medium described herein, the frequency resource allocation pattern may be associated with a demodulation reference signal sequence associated with the first portion of the sidelink control message, a demodulation reference signal comb index, or both.

In some examples of the method, apparatuses, and non-transitory computer-readable medium described herein, the additional control information includes sidelink broadcast channel signaling.

### BRIEF DESCRIPTION OF THE DRAWINGS

FIG. 1 illustrates an example of a wireless communications system that supports the use of a wideband sidelink synchronization signal block in accordance with one or more examples as disclosed herein.

FIG. 2 illustrates an example of a wireless communications system that supports the use of a wideband sidelink synchronization signal block in accordance with one or more examples as disclosed herein.

FIG. 3 illustrates an example of a sidelink synchronization block configuration that supports the use of a wideband sidelink synchronization signal block in accordance with one or more examples as disclosed herein.

FIG. 4 illustrates an example of a sidelink synchronization block configuration that supports the use of a wideband sidelink synchronization signal block in accordance with one or more examples as disclosed herein.

FIG. 5 illustrates an example of a sidelink synchronization block configuration that supports the use of a wideband sidelink synchronization signal block in accordance with one or more examples as disclosed herein.

FIG. 6 illustrates an example of a sidelink synchronization block configuration that supports the use of a wideband sidelink synchronization signal block in accordance with one or more examples as disclosed herein.

FIG. 7 illustrates an example of a process flow that supports the use of a wideband sidelink synchronization signal block in accordance with one or more examples as disclosed herein.

FIGS. 8 and 9 illustrate block diagrams of devices that support the use of a wideband sidelink synchronization signal block in accordance with one or more examples as disclosed herein.

FIG. 10 illustrates a block diagram of a communications manager that supports the use of a wideband sidelink synchronization signal block in accordance with one or more examples as disclosed herein.

FIG. 11 illustrates a diagram of a system including a device that supports the use of a wideband sidelink synchronization signal block in accordance with one or more examples as disclosed herein.

FIGS. 12 through 16 illustrate flowcharts showing methods that support the use of a wideband sidelink synchronization signal block in accordance with one or more examples as disclosed herein.

### DETAILED DESCRIPTION

In sidelink wireless communications, a first user equipment (UE) may transmit a sidelink synchronization signal block (S-SSB) to aid a second UE in establishing sidelink communications with the first UE. In some cases, such a S-SSB may not satisfy an occupied channel bandwidth (OCB) threshold because the S-SSB may not occupy an amount of bandwidth that may satisfy the OCB (e.g., 80% of a 20 MHz band).

A first UE may generate a first portion of a sidelink control message (e.g., an S-SSB) that includes a first portion that includes one or more synchronization signals (e.g., a primary synchronization signal, such as a sidelink primary synchronization signal (SPSS), a secondary synchronization signal, such as a sidelink secondary synchronization signal) and the first portion of the sidelink control message may occupy a first portion of a bandwidth that meets an OCB threshold. Such signaling may be referred to as “narrowband” signaling. The UE may also generate a second portion of the sidelink control message that includes control or data signaling and the second portion of the sidelink control message may occupy the remaining portion of the bandwidth that does not include the first portion of the sidelink control message. For example, the second portion of the sidelink control message may “fill in” the remaining bandwidth so that the total bandwidth of the sidelink control message satisfies the OCB threshold. In some examples, the second portion of the sidelink control message may include signaling that is rate-matched to signaling in the first portion of the sidelink control message to “fill in” the remaining frequency resources. Additionally, or alternatively, the second portion of the sidelink control message may include one or more repetitions (e.g., in the frequency domain) of control or data signaling to “fill in” the remaining frequency resources. In this way, the OCB threshold may be satisfied while maintaining “narrowband”signaling for compatibility with legacy UEs.

Aspects of the disclosure are initially described in the context of wireless communications systems. Aspects of the disclosure are then described with reference to a wireless communications system, example S-SSB configurations, and a process flow. Aspects of the disclosure are further illustrated by and described with reference to apparatus diagrams, system diagrams, and flowcharts that relate to wideband sidelink synchronization signal block.

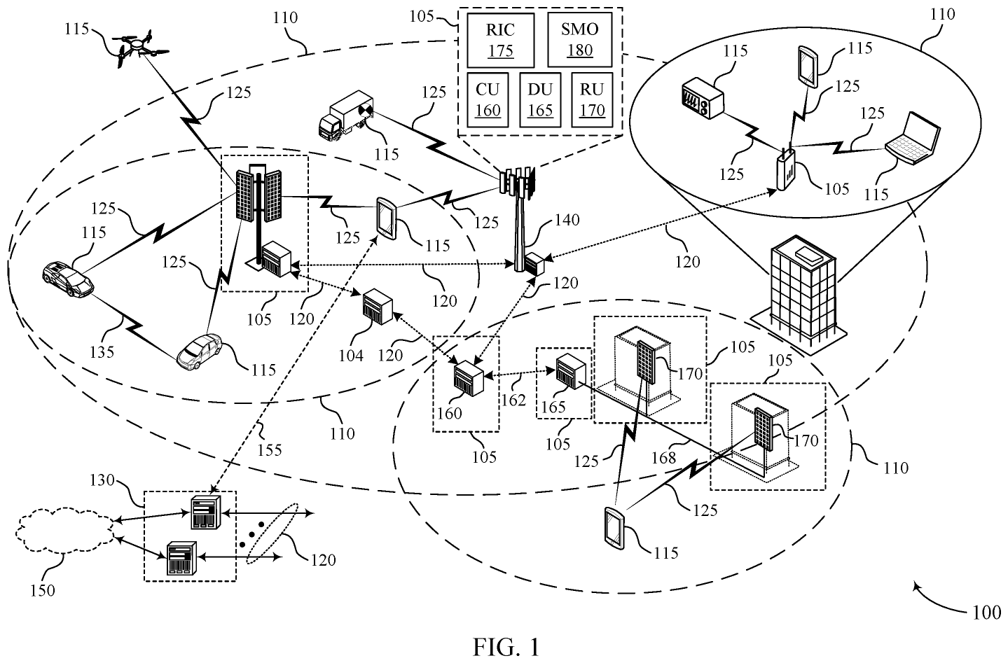

FIG. 1 illustrates an example of a wireless communications system 100 that supports the use of a wideband sidelink synchronization signal block in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support the use of a wideband sidelink synchronization signal block as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE communicating in sidelink may transmit sidelink control signaling (e.g., an S-SSB) that includes a first portion that includes one or more synchronization signals and a second portion that includes other signaling (e.g., control signaling, data signaling, or both). The second portion may be modified to have a bandwidth such that a combined bandwidth of the first portion and the second portion may satisfy an OCB threshold. For example, the second portion may include signaling that is rate-matched (e.g., in the frequency domain) to expand the bandwidth of the second portion. Additionally, or alternatively, the second portion may include signaling that is repeated in the frequency domain to expand the bandwidth of the second portion. In this way, the S-SSB may include a bandwidth that satisfies the OCB threshold even though the first portion of the S-SSB that includes the synchronization signaling may not satisfy the OCB threshold alone.

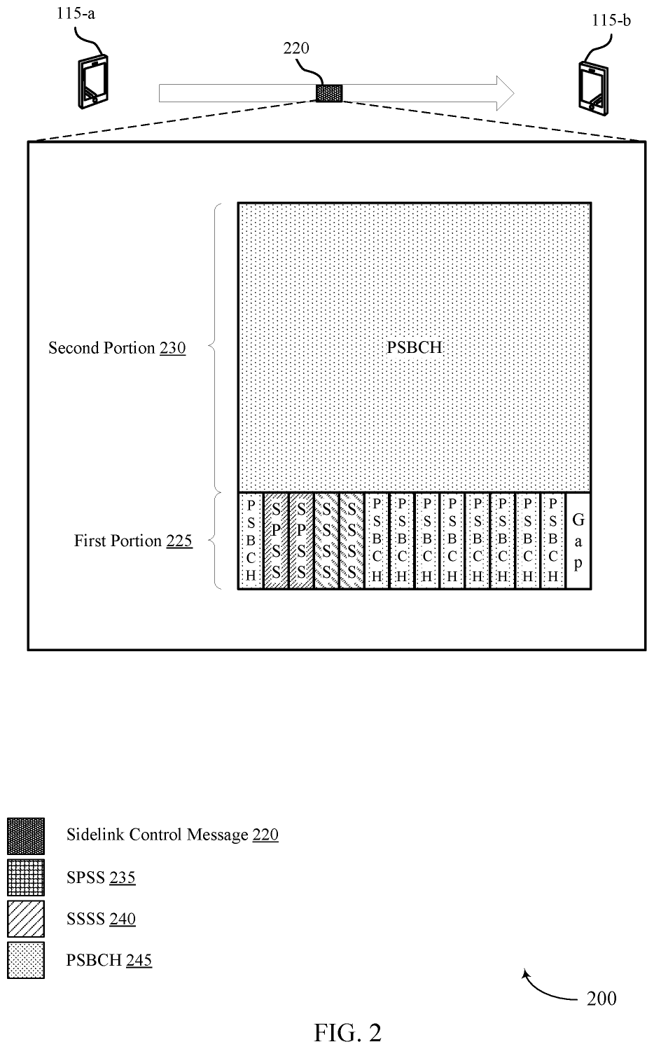

FIG. 2 illustrates an example of a wireless communications system 200 that supports the use of a wideband sidelink synchronization signal block in accordance with one or more examples as disclosed herein. The wireless communications system 200 may include a first UE 115-a and a second UE 115-b. The first UE 115-a and the second UE 115-b may communicate via sidelink communications.

Some sidelink wireless communications scenarios may employ the use of a synchronization block, such as an S-SSB to establish sidelink communications between UEs. In some examples, the S-SSB may include a structure with a quantity of RBs (e.g., such as eleven RBs, some or all of which may be uniform) and full slot transmission (e.g., fourteen total 14 symbols, optionally including a gap symbol. Once such example of portions of an S-SSB is included in the first portion 225 of the sidelink control message 220. However, such signaling may not meet an OCB requirement by itself. For example, a bandwidth of such signaling may be less than a bandwidth specified in an OCB requirement. Further, in some examples, such an S-SSB may be incompatible for multiplexing with other signals (e.g., PSCCH transmissions or PSSCH transmissions), For example, the RB structure may not match or may not be compatible with a resource pool structure of one or more other signals (e.g., the PSCCH transmissions or PSSCH transmissions).

Some approaches may employ wideband rate matching (e.g., of PSBCH signaling) around the SPSS 235 and the SSSS 240. However, if multiple synchronization rasters (e.g., synchronization rasters 320 described herein) are employed within one RB set (e.g., a 20 MHz subband) or within a bandwidth occupies by the sidelink control message 220, then a device may not correctly interpret which RB or RSs may be the starting RBs of the wideband rate-matched portion.

Further, some UEs may not have capabilities for decoding such wideband signaling. As such, to continue support for such UEs, the narrowband portion of the sidelink control message 220 (e.g., the first portion 225) may be maintained as part of the overall wideband structure. The second portion 230 may include a complimentary signal included at least for bandwidth occupancy reasons as well as to support UEs that may include a capacity for decoding such wideband signaling (e.g., PSBCH signaling).

A first UE 115-a may generate the first portion 225 of a sidelink control message 220 (e.g., an S-SSB) that includes the first portion 225 that includes one or more synchronization signals (e.g., the SPSS 235, the SSSS 240, or both). The first portion 225 of the S-SSB may occupy a first portion of an overall bandwidth (e.g., of the first portion 225 and the second portion 230) that meets an OCB threshold. Such signaling may be referred to as “narrowband” signaling. The UE may also generate a second portion 230 of the sidelink control message 220 that includes control or data signaling (e.g., PSBCH 245) and the second portion 230 of the sidelink control message 220 may occupy the remaining portion of the bandwidth that does not include the first portion 225 of the sidelink control message. For example, the second portion 230 of the sidelink control message 220 may “fill in” the remaining bandwidth so that the total bandwidth of the sidelink control message 220 satisfies the OCB threshold. In some examples, the second portion 230 of the sidelink control message may include signaling that is rate-matched to signaling in the first portion of the sidelink control message to “fill in” the remaining frequency resources. Additionally, or alternatively, the second portion 230 of the sidelink control message may include one or more repetitions (e.g., in the frequency domain) of control or data signaling to “fill in” the remaining frequency resources. In this way, the OCB threshold may be satisfied while maintaining “narrowband”signaling for compatibility with legacy UEs.

In some examples, the synchronization raster 320 may indicate a frequency position or set of frequency resources where the first portion 225 may be located.

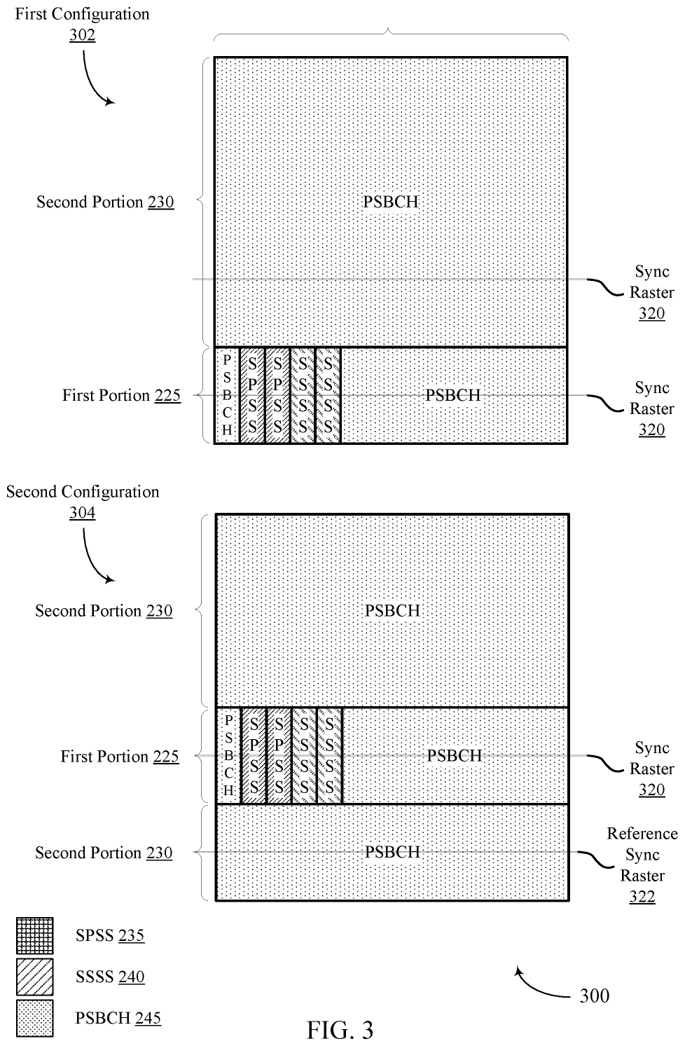

FIG. 3 illustrates an example of a sidelink synchronization block configuration 300 that supports the use of a wideband sidelink synchronization signal block in accordance with one or more examples as disclosed herein.

In some examples, a UE may transmit a sidelink control message including the first portion 225 and the second portion 230. In some examples, the first portion 225 (also referred to as a narrowband portion) may be S-SSB as described herein or may be an S-SSB of another configuration (e.g., a twenty RB S-SSB that includes four, five, six, or seven symbols). In some examples, a DMRS of the PSBCH 245 signaling may be mapped to the first portion 225 (e.g., by frequency first and by symbol second). In some examples, a receiving UE may decode the first portion 225 independently from decoding (or not decoding) the second portion 230. For example, a UE may decode the first portion 225 and ignore the second portion.

In some examples, the PSBCH 245 signaling (e.g., the PSBCH 245 signaling of the first portion 225, PSBCH 245 of the second portion 230, or both) may be rate-matched to occupy the full bandwidth of the first configuration 302 (e.g., of a sidelink control message). Such a full bandwidth may be a 20 MHz bandwidth. In some examples, the rate-matching (e.g., DMRS and PSBCH rate matching) may continue after the first portion 225. Such rate matching may be performed in accordance with a rate matching pattern. For example, the rate-matching may start with a lowest frequency and first time resource of the second portion 230. In some examples, a DMRS sequence may be continued after the first portion 225 in the second portion 230 from a lowest frequency and first symbol resource, optionally using a comb pattern (e.g., comb-4) in frequency first and then by symbol. In some examples, the rate-matching of the second portion 230 may be continued after the first portion 225 in the second portion 230, optionally by frequency first and by symbol second. In some examples, the rate-matching described herein may avoid one or more resources elements associated with a DMRS.

In some examples, instead of continuing rate-matching from the first portion 225 to the second portion 230, the rate-matching may be performed independently from rate-matching performed in the first portion 225. For example, a rate-matching process may be restarted for rate-matching performed for the second portion 230.

In some examples, multiple synchronization rasters may be employed. For example, the first portion 225 may be centered on or associated with a synchronization raster 320. As such, a device may not correctly interpret the synchronization rasters 320 to determine at which frequencies the first portion 225, the second portion 230, or both, may be located. To mitigate such problems, one or more wideband frequency patterns (e.g., associated with the second portion 230 or the PSBCH 245 signaling) may be established. Such frequency patterns may indicate different configurations or patterns of the first portion 225, the second portion 230, or both. Such patterns may therefore accommodate or described patterns such as the first configuration 302, the second configuration 304, or both. In the first configuration 302, the second portion 230 may be a continuous block of RBs, whereas, in the second configuration 304, the second portion 230 may be split into two or more blocks of RBs. For example, the first portion 225 may be located in between (e.g., in frequency) multiple parts of the second portion 230.

In some examples where the second portion 230 includes rate-matched signaling, frequency patterns (e.g., indicating one or more locations of the first portion 225, the second portion 230, or both) may be defined in terms of an RB offset to the first portion 225 and a bandwidth of the second portion 230. In some such examples, it may be assumed that any resources of the second portion 230 that may overlap with the first portion 225 are unused. In some examples (e.g., to economize the use of code points), the RB offset may be defined with respect to a 0th RB of resources where a first portion 225 might have been located were it not located somewhere else.

For example, in the second configuration 304, the first portion 225 is associated with the synchronization raster 320, but could have been associated with the reference synchronization raster 322. As such, the RB offset may be defined relative to the 0th RB of resources where the first portion 225 would have started had it been associated with the reference synchronization raster 322 (e.g., even though the actual first portion 225 is associated with the synchronization raster 320). Additionally, or alternatively, a bandwidth of the second portion 230 may be a fixed bandwidth and such a bandwidth may be indicated to a device receiving a sidelink control message.

In some examples, different sequences of the PSBCH 245 signaling of the first portion 225 may be included in the first portion 225 to indicate different DMRS sequences, different DMRS comb patterns or indices, or both, to indicate different patterns of the second portion 230. For example, assuming that there exists a limited quantity of frequency patterns across multiple subbands (e.g., 8 patterns), different sequences (e.g., pseudo-random sequences) may be used by setting different initialization values for a DMRS. For example, an initialization value cᵢₙᵢₜ may be expressed as cᵢₙᵢₜ=f(N_{ID}^{SL},m), in which m may be a pattern index. In some examples, a DMRS may accept a limited quantity of comb patterns or configurations. As such, different comb patterns or indices may be used to signal or indicate the use of different frequency patterns of the second portion 230.

Though the discussion of frequency patterns of the second portion 230 are discussed in the context of a rate-matching scheme, all such discussion also applies to techniques involving repetition of signaling used within the second portion 230.

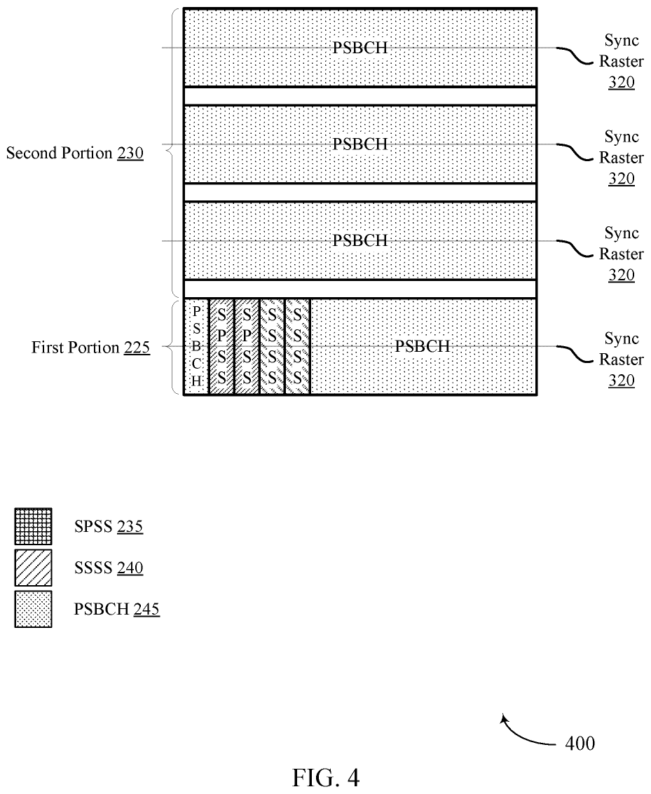

FIG. 4 illustrates an example of a sidelink synchronization block configuration 400 that supports the use of a wideband sidelink synchronization signal block in accordance with one or more examples as disclosed herein.

In some examples, instead of or in addition to rate-matching signaling of the second portion 230 to fill bandwidth of a sidelink control message, such signaling may be repeated across the frequency domain (e.g., in a uniform or periodic manner) to occupy the bandwidth and satisfy an OCB parameter. For example, as depicted in FIG. 4, the PSBCH 245 signaling may be repeated across the frequency domain in the second portion 230. In some examples, the PSBCH 245 signaling of the first portion 225 may be repeated across the frequency domain into the second portion 230, and the repetitions of the PSBCH 245 signaling (e.g., and, optionally, any associated DMRS signaling) in the second portion 230 may be rate-matched into time resources that are occupied by the SPSS 235 and the SSSS 240 in the first portion 225. In other words, the PSBCH 245 signaling may be rate-matched to expand, in time, the signaling of the second portion 230 so that the signaling of the second portion 230 is of the same or similar length (e.g., within a threshold) as the signaling included in the first portion 225.

In some examples, the repetitions of the PSBCH 245 signaling or other signaling in the second portion 230 may be performed with one or more techniques. In a first technique, the rate-matching may be performed from a first symbol to the last symbol (e.g., including symbols from the SPSS 235 symbols, SSSS 240 symbols, or both, from the first portion 225). Additionally, or alternatively, the rate-matching of signaling in the second portion 230 may follow the order of PSBCH 245 signaling in the first portion 225 and may continue in the time resources associated with the SPSS 235, the SSSS 240, or both.

However, in some cases, such approaches may be associated with a peak-to-average power ratio (PAPR) that may be higher than in other approaches (e.g., due to the repetition of signaling in the second portion 230). As such, one or more techniques may be employed to reduce such a PAPR. For example, different initialization values may be used for a DMRS, data scrambling (e.g., before symbol modulation), or both that are associated with one or more different repetitions of signaling in the second portion 230. In some examples, DMRS and data scrambling may use the same sequence generator with a same initialization value. For example, an initialization value for an i-th frequency repetition of signaling in the second portion 230 may be expressed as cᵢₙᵢₜ=f(N_{ID}^{SL},i) (e.g., instead of the unmodified initialization value of cᵢₙᵢₜ=N_{SL}^{ID}. In cases involving modification of the initialization variable for data scrambling, a PSBCH 245 signaling payload may be unscrambled for a first stage of scrambling, but the second stage of scrambling may still be applied before symbol modulation.

Additionally, or alternatively, one or more other techniques may be used to reduce a PAPR associated with the frequency domain repetitions of signaling in the second portion 230. For example, a different rate-matching pattern (e.g., for the rate-matching for such repetitions as described herein) may be used for different frequency domain repetitions. For example, a first rate-matching pattern may be done in frequency first and by symbol second (e.g., from a first symbol in time to a last symbol in time) for a first repetition, and rate-matching for a second repetition may be performed with a different pattern (e.g., from a last symbol in time to a first symbol in time).

In some examples (e.g., and as described herein), different frequency patterns that indicate frequency locations of the first portion 225, the second portion 230, or both, may be employed, particularly in situations where multiple synchronization rasters 320 may be present in or associated with frequency resources of the sidelink control message (e.g., an S-SSB). In examples in which signaling is repeated in the frequency domain in the second portion 230, such frequency patterns may indicate or be defined in terms of one or more of the following: a quantity of RB frequency blocks associated with the first portion 225 (e.g., a quantity of frequency blocks associated with a pattern of eleven RBs or twenty RBs associated with the first portion 225); a gap between the frequency blocks (e.g., assuming that all blocks are evenly spaced in frequency); a block index (e.g., of the quantity of RB frequency blocks) in which the first portion 225 is located; or any combination thereof.

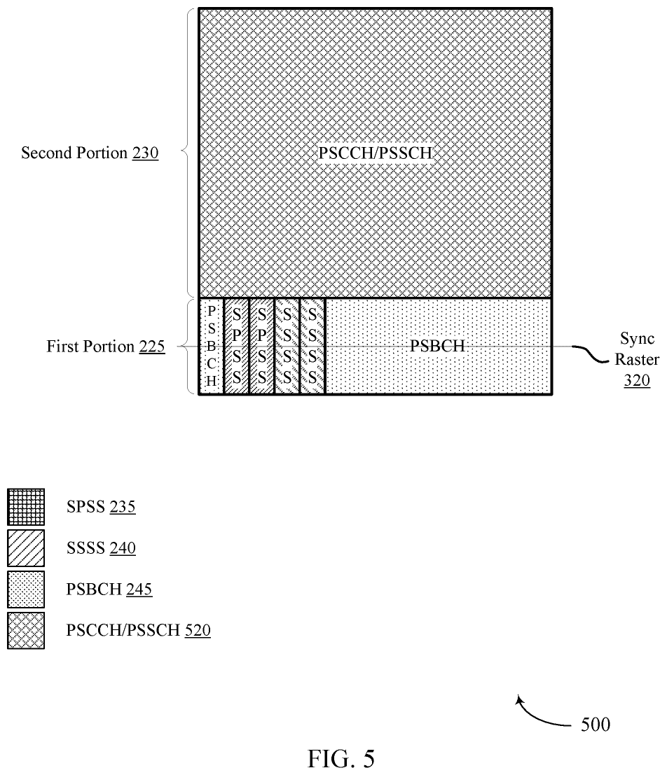

FIG. 5 illustrates an example of a sidelink synchronization block configuration 500 that supports the use of a wideband sidelink synchronization signal block in accordance with one or more examples as disclosed herein.

In some examples, instead of transmitting PSBCH signaling 245 in the second portion 230, other signaling may be transmitted. In some examples, such other signaling may be transmitted if the slot of the sidelink control message (e.g., an S-SSB) is within a resource pool. For example, PSCCH/PSSCH 520 signaling may be transmitted (e.g., such signaling may include PSCCH signaling, PSSCH signaling, or both). Such an approach may be described as opportunistically multiplexing signaling of the first portion 225 with other data signaling, control signaling, or both. For example, if a transmitting device (e.g., the first UE 115-a) has data to transmit to the receiving device (e.g., the second UE 115-b) the transmitting device may drop the wideband PSBCH 245 signaling and multiplex the PSCCH/PSSCH 520 signaling instead. In some examples, transmitting both PSBCH 245 signaling and the PSCCH/PSSCH 520 signaling may not be desirable and avoiding such a situation may be favorable, as the PSCCH/PSSCH 520 may collide with other synchronization references (e.g., a syncRef) is there is PSBCH 245 signaling present in the second portion 230.

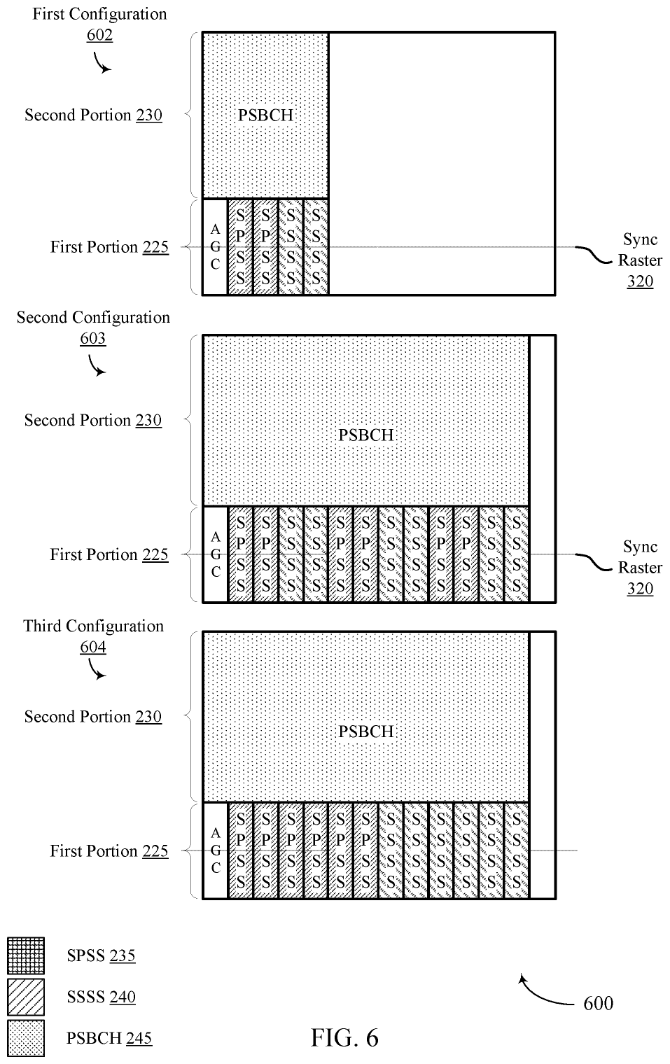

FIG. 6 illustrates an example of a sidelink synchronization block configuration 600 that supports the use of a wideband sidelink synchronization signal block in accordance with one or more examples as disclosed herein.

In some examples, the first portion 225 may not include PSBCH 245 signaling. Instead, the first portion 225 may include a first symbol for automatic gain control (AGC), one or more SPSSs 235, one or more SSSSs 240, or any combination thereof. Correspondingly, the second portion 230 may include additional signaling (e.g., PSBCH 245 signaling) that is used to “fill” the bandwidth such that the sidelink control signaling satisfies the OCB parameter. Such additional signaling may be of a length that matches a length of the signaling included in the first portion 225. In some examples, the signaling in the second portion 230 may be rate-matched or repeated in the frequency domain (e.g., as described herein). In some examples, a receiving device may be employing a SPSS 235 or SSSS 240 searcher, in which case the receiving device is searching for a pattern of 2 SPSSs 235 and 2 SSSSs 240. In such examples, such a structure may be maintained in the first portion 225 to maintain compatibility with such searches.

For example, in the first configuration 602, the first portion 225 may includes a single AGC symbol, two SPSS 235 symbols, and two SSSS 240 symbols. The time resources that would have otherwise includes PSBCH 245 signaling are omitted the first portion 225, the second portion 230, or both. In some examples, as in the first configuration 602, this may result in a shortened sidelink control message.

However, in other examples, repetition of the SPSS 235, the SSSS 240, or both, may be employed. For example, in some cases, a maximum transmit power associated with the S-SSB may be limited, and repetition may be desirable.

For example, in the second configuration 603, a pattern of two SPSSs 235 and two SSSSs 240 is repeated in the first portion. In a further example, the third configuration 604 includes six SPSSs 235 and six SSSSs 240. In any of the configurations described herein, the PSBCH 245 signaling of the second portion 230 may be expanded (e.g., via rate-matching, repetition, or both) to occupy remaining RBs in the sidelink control signaling (e.g., S-SSB) such that the OCB parameter is satisfied.

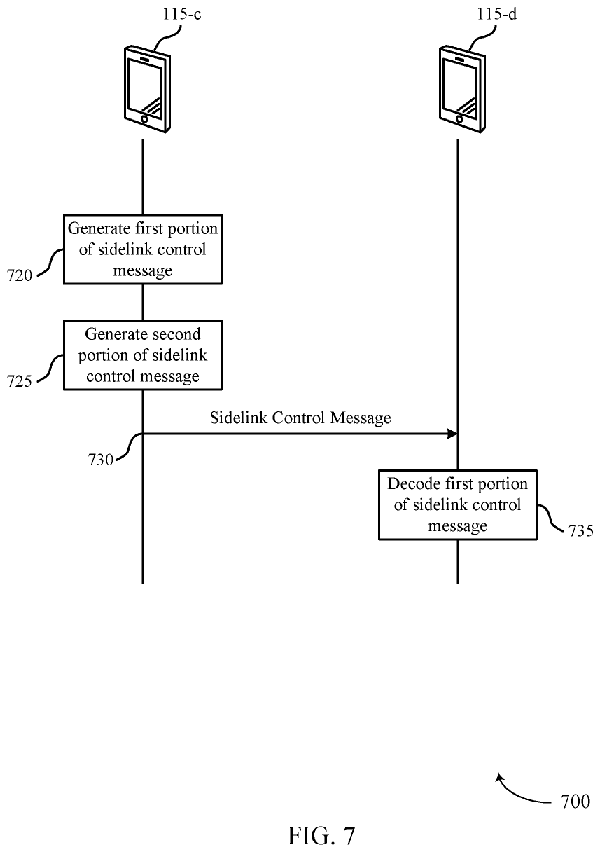

FIG. 7 illustrates an example of a process flow 700 that supports the use of a wideband sidelink synchronization signal block in accordance with one or more examples as disclosed herein. The process flow 700 may implement various aspects of the present disclosure described herein. The elements described in the process flow 700 may be examples of similarly-named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the UE 115-c may generate a first portion of a sidelink control message and the first portion of the sidelink control message may include a primary synchronization signal and a secondary synchronization signal occupying a first subset of a bandwidth of the sidelink control message.

In some examples, the sidelink control message may be associated with a quantity of synchronization rasters. In some examples, the first portion of the sidelink control message and the second portion of the sidelink control message may be generated in accordance with a frequency resource allocation pattern that is based on the quantity of synchronization rasters and one or more frequency domain locations of the quantity of synchronization rasters. In some examples, the frequency resource allocation pattern may be based on a resource block offset associated with the first portion of the sidelink control message and a bandwidth of the second portion of the sidelink control message. In some examples, the frequency resource allocation pattern may be based on a quantity of resource blocks associated with the first portion of the sidelink control message, one or more gaps between the resource blocks, a block index associated with the first portion of the sidelink control message, or any combination thereof. In some examples, the frequency resource allocation pattern may be associated with a demodulation reference signal sequence associated with the first portion of the sidelink control message, a demodulation reference signal comb index, or both.

At 725, the UE 115-c may generate a second portion of the sidelink control message to occupy a second subset of the bandwidth of the sidelink control message such that the bandwidth of the sidelink control message satisfies an occupied channel bandwidth threshold and the second portion of the sidelink control message may include additional control information or additional data information that is encoded such that the first portion is decodable independent of a successful decoding of the second portion. In some examples, the additional control information may include sidelink broadcast channel signaling.

In some examples, the additional control information or additional data information comprised in the second portion of the sidelink control message may be rate-matched to occupy the second subset of the bandwidth of the sidelink control message. In some examples, the additional control information or additional data information may be rate-matched based on rate-matched control information comprised in the first portion of the sidelink control message. In some examples, the additional control information or additional data information may be rate-matched based on rate-matched control information comprised in the first portion of the sidelink control message. In some examples, the additional control information or additional data information may be rate-matched independently from rate-matched control information comprised in the first portion of the sidelink control message.

In some examples, the second portion of the sidelink control message may include frequency domain repetitions of the additional control information or additional data information. In some examples, the frequency domain repetitions may be rate-matched to occupy time resources corresponding to symbols of the primary synchronization signal and the secondary synchronization signal. In some examples, the frequency domain repetitions may be rate-matched from a first symbol to a last symbol or in accordance with a rate-matching order of control information comprised in the first portion of the sidelink control message. In some examples, each demodulation reference signal associated with a respective frequency domain repetition may be based on different initialization values. In some examples, the additional control information may include sidelink broadcast channel signaling rate-matched in accordance with a first rate-matching pattern and one or more demodulation reference signals rate-matched in accordance with a second rate-matching pattern different than the first rate-matching pattern.

In some examples, the additional control information may include sidelink control channel signaling, the additional data information may include sidelink shared channel signaling, or both.

In some examples, the sidelink control message may be associated with a quantity of synchronization rasters. In some examples, the first portion of the sidelink control message and the second portion of the sidelink control message may be generated in accordance with a frequency resource allocation pattern that may be based on the quantity of synchronization rasters and one or more frequency domain locations of the quantity of synchronization rasters. In some examples, the frequency resource allocation pattern may be based on a resource block offset associated with the first portion of the sidelink control message and a bandwidth of the second portion of the sidelink control message. In some examples, the frequency resource allocation pattern may be based on a quantity of resource blocks associated with the first portion of the sidelink control message, one or more gaps between the resource blocks, a block index associated with the first portion of the sidelink control message, or any combination thereof. In some examples, the frequency resource allocation pattern may be associated with a demodulation reference signal sequence associated with the first portion of the sidelink control message, a demodulation reference signal comb index, or both.

At 730, the UE 115-c may transmit the sidelink control message to the UE 115-d.

At 735, the UE 115-d may decode the first portion of the sidelink control message. The UE 115-c may decode the first portion of the sidelink control message independently from a successful decoding of the second portion of the sidelink control message.

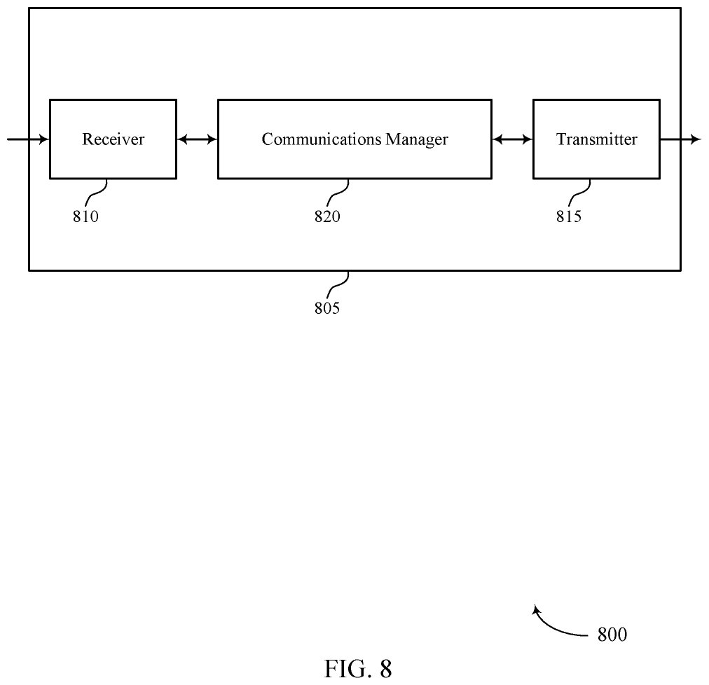

FIG. 8 illustrates a block diagram 800 of a device 805 that supports the use of a wideband sidelink synchronization signal block in accordance with one or more examples as disclosed herein. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to wideband sidelink synchronization signal block). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to wideband sidelink synchronization signal block). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of wideband sidelink synchronization signal block as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications at a first UE in accordance with examples as disclosed herein. For example, the communications manager 820 may be configured as or otherwise support a means for generating a first portion of a sidelink control message, where the first portion of the sidelink control message includes a primary synchronization signal and a secondary synchronization signal occupying a first subset of a bandwidth of the sidelink control message. The communications manager 820 may be configured as or otherwise support a means for generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. The communications manager 820 may be configured as or otherwise support a means for transmitting the sidelink control message to a second UE.

Additionally, or alternatively, the communications manager 820 may support wireless communications at a second UE in accordance with examples as disclosed herein. For example, the communications manager 820 may be configured as or otherwise support a means for decoding a first portion of a sidelink control message, the first portion of the sidelink control message including a primary synchronization signal and a secondary synchronization signal that occupy a first subset of a bandwidth of the sidelink control message. The communications manager 820 may be configured as or otherwise support a means for where the sidelink control message further including a second portion of the sidelink control message that occupies a second subset of the bandwidth of the sidelink control message such that the bandwidth of the sidelink control message satisfies an occupied channel bandwidth threshold, the second portion of the sidelink control message including additional control information or additional data information that is encoded such that the first portion is decoded independent of a successful decoding of the second portion.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, more efficient utilization of communication resources, or any combination thereof.

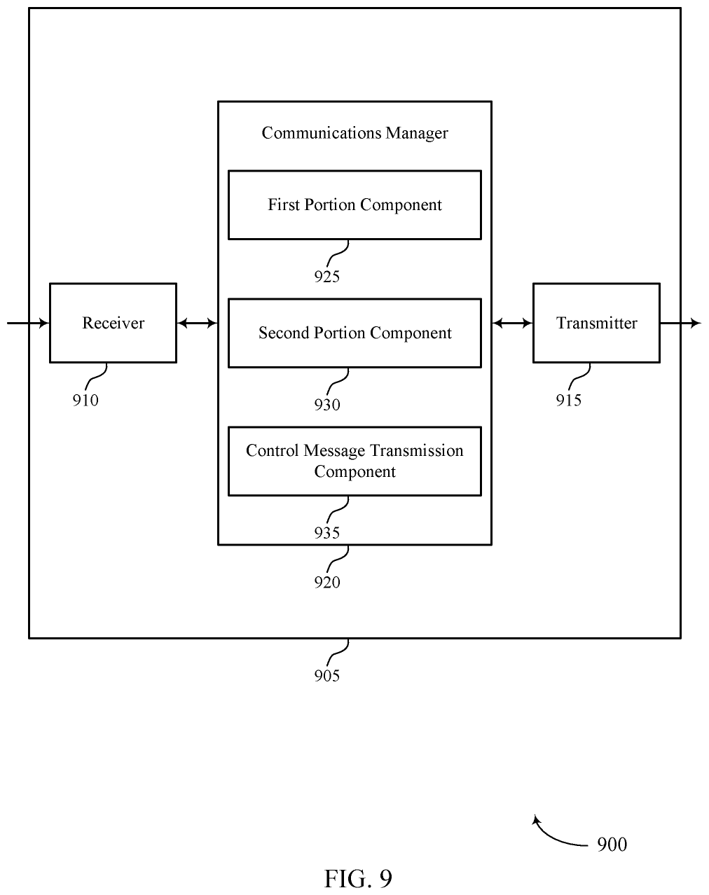

FIG. 9 illustrates a block diagram 900 of a device 905 that supports the use of a wideband sidelink synchronization signal block in accordance with one or more examples as disclosed herein. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to wideband sidelink synchronization signal block). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to wideband sidelink synchronization signal block). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of wideband sidelink synchronization signal block as described herein. For example, the communications manager 920 may include a first portion component 925, a second portion component 930, a control message transmission component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first UE in accordance with examples as disclosed herein. The first portion component 925 may be configured as or otherwise support a means for generating a first portion of a sidelink control message, where the first portion of the sidelink control message includes a primary synchronization signal and a secondary synchronization signal occupying a first subset of a bandwidth of the sidelink control message. The second portion component 930 may be configured as or otherwise support a means for generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. The control message transmission component 935 may be configured as or otherwise support a means for transmitting the sidelink control message to a second UE.

Additionally, or alternatively, the communications manager 920 may support wireless communications at a second UE in accordance with examples as disclosed herein. The first portion component 925 may be configured as or otherwise support a means for decoding a first portion of a sidelink control message, the first portion of the sidelink control message including a primary synchronization signal and a secondary synchronization signal that occupy a first subset of a bandwidth of the sidelink control message. The second portion component 930 may be configured as or otherwise support a means for where the sidelink control message further includes a second portion of the sidelink control message that occupies a second subset of the bandwidth of the sidelink control message such that the bandwidth of the sidelink control message satisfies an occupied channel bandwidth threshold, the second portion of the sidelink control message including additional control information or additional data information that is encoded such that the first portion is decoded independent of a successful decoding of the second portion.

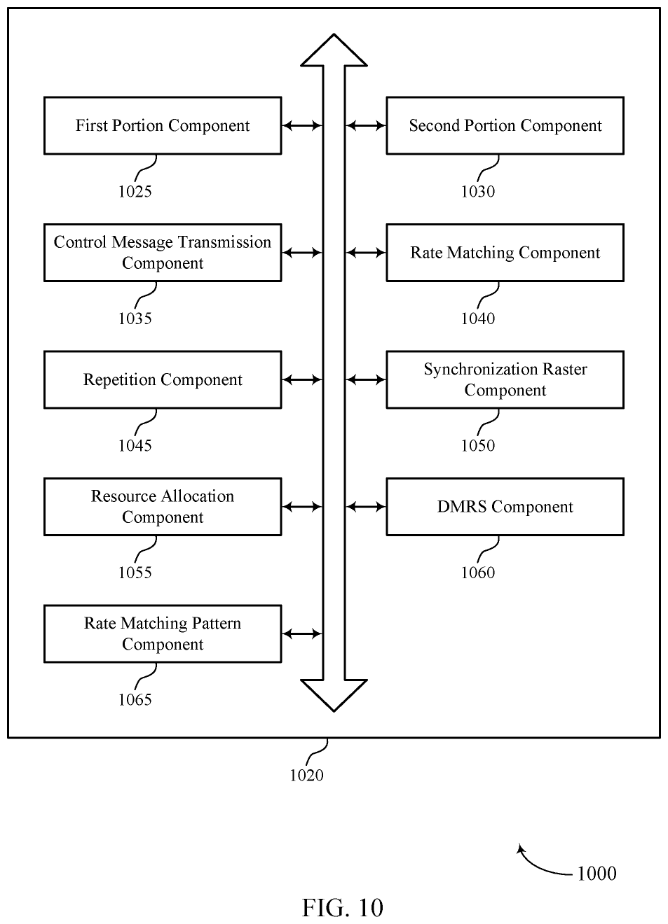

FIG. 10 illustrates a block diagram 1000 of a communications manager 1020 that supports wideband sidelink synchronization signal block in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of wideband sidelink synchronization signal block as described herein. For example, the communications manager 1020 may include a first portion component 1025, a second portion component 1030, a control message transmission component 1035, a rate matching component 1040, a repetition component 1045, a synchronization raster component 1050, a resource allocation component 1055, a DMRS component 1060, a rate matching pattern component 1065, or any combination thereof. Each of these components may communicate, directly or indirectly, with one another (e.g., via one or more buses).

Additionally, or alternatively, the communications manager 1020 may support wireless communications at a first UE in accordance with examples as disclosed herein. The first portion component 1025 may be configured as or otherwise support a means for generating a first portion of a sidelink control message, where the first portion of the sidelink control message includes a primary synchronization signal and a secondary synchronization signal occupying a first subset of a bandwidth of the sidelink control message. The second portion component 1030 may be configured as or otherwise support a means for generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. The control message transmission component 1035 may be configured as or otherwise support a means for transmitting the sidelink control message to a second UE.

In some examples, the additional control information or additional data information included in the second portion of the sidelink control message is rate-matched to occupy the second subset of the bandwidth of the sidelink control message.

In some examples, the additional control information or additional data information is rate-matched based on rate-matched control information included in the first portion of the sidelink control message.

In some examples, the additional control information or additional data information is rate-matched beginning with a lowest frequency resource of the second portion and a first time resource of the second portion of the sidelink control message.

In some examples, the additional control information or additional data information is rate-matched independently from rate-matched control information included in the first portion of the sidelink control message.

In some examples, the second portion of the sidelink control message includes frequency domain repetitions of the additional control information or additional data information.

In some examples, the frequency domain repetitions are rate-matched to occupy time resources corresponding to symbols of the primary synchronization signal and the secondary synchronization signal.

In some examples, the frequency domain repetitions are rate-matched from a first symbol to a last symbol or in accordance with a rate-matching order of control information included in the first portion of the sidelink control message.

In some examples, each demodulation reference signal associated with a respective frequency domain repetition is based on different initialization values.

In some examples, the additional control information includes sidelink broadcast channel signaling rate-matched in accordance with a first rate-matching pattern and one or more demodulation reference signals rate-matched in accordance with a second rate-matching pattern different than the first rate-matching pattern.

In some examples, the additional control information includes sidelink control channel signaling, the additional data information includes sidelink shared channel signaling, or both.

In some examples, the sidelink control message is associated with a quantity of synchronization rasters. In some examples, the first portion of the sidelink control message and the second portion of the sidelink control message are generated in accordance with a frequency resource allocation pattern that is based on the quantity of synchronization rasters and one or more frequency domain locations of the quantity of synchronization rasters.

In some examples, the frequency resource allocation pattern is based on a resource block offset associated with the first portion of the sidelink control message and a bandwidth of the second portion of the sidelink control message.

In some examples, the frequency resource allocation pattern is based on a quantity of resource blocks associated with the first portion of the sidelink control message, one or more gaps between the resource blocks, a block index associated with the first portion of the sidelink control message, or any combination thereof.

In some examples, the frequency resource allocation pattern is associated with a demodulation reference signal sequence associated with the first portion of the sidelink control message, a demodulation reference signal comb index, or both.

In some examples, the additional control information includes sidelink broadcast channel signaling.

Additionally, or alternatively, the communications manager 1020 may support wireless communications at a second UE in accordance with examples as disclosed herein. In some examples, the first portion component 1025 may be configured as or otherwise support a means for decoding a first portion of a sidelink control message, the first portion of the sidelink control message including a primary synchronization signal and a secondary synchronization signal that occupy a first subset of a bandwidth of the sidelink control message. In some examples, the second portion component 1030 may be configured as or otherwise support a means for where the sidelink control message further includes a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

In some examples, the additional control information or additional data information included in the second portion of the sidelink control message is rate-matched to occupy the second subset of the bandwidth of the sidelink control message.

In some examples, the additional control information or additional data information is rate-matched based on rate-matched control information included in the first portion of the sidelink control message.

In some examples, the additional control information or additional data information is rate-matched beginning with a lowest frequency resource of the second portion and a first time resource of the second portion of the sidelink control message.

In some examples, the additional control information or additional data information is rate-matched independently from rate-matched control information included in the first portion of the sidelink control message.

In some examples, the second portion of the sidelink control message includes frequency domain repetitions of the additional control information or additional data information.

In some examples, the frequency domain repetitions are rate-matched to occupy time resources corresponding to symbols of the primary synchronization signal and the secondary synchronization signal.

In some examples, the frequency domain repetitions are rate-matched from a first symbol to a last symbol or in accordance with a rate-matching order of control information included in the first portion of the sidelink control message.

In some examples, each demodulation reference signal associated with a respective frequency domain repetition is based on different initialization values.

In some examples, the additional control information includes sidelink broadcast channel signaling rate-matched in accordance with a first rate-matching pattern and one or more demodulation reference signals rate-matched in accordance with a second rate-matching pattern different than the first rate-matching pattern.

In some examples, the additional control information includes sidelink control channel signaling, the additional data information includes sidelink shared channel signaling, or both.

In some examples, the sidelink control message is associated with a quantity of synchronization rasters. In some examples, the first portion of the sidelink control message and the second portion of the sidelink control message are generated in accordance with a frequency resource allocation pattern that is based on the quantity of synchronization rasters and one or more frequency domain locations of the quantity of synchronization rasters.

In some examples, the frequency resource allocation pattern is based on a resource block offset associated with the first portion of the sidelink control message and a bandwidth of the second portion of the sidelink control message.

In some examples, the frequency resource allocation pattern is based on a quantity of resource blocks associated with the first portion of the sidelink control message, one or more gaps between the resource blocks, a block index associated with the first portion of the sidelink control message, or any combination thereof.

In some examples, the frequency resource allocation pattern is associated with a demodulation reference signal sequence associated with the first portion of the sidelink control message, a demodulation reference signal comb index, or both.

In some examples, the additional control information includes sidelink broadcast channel signaling.

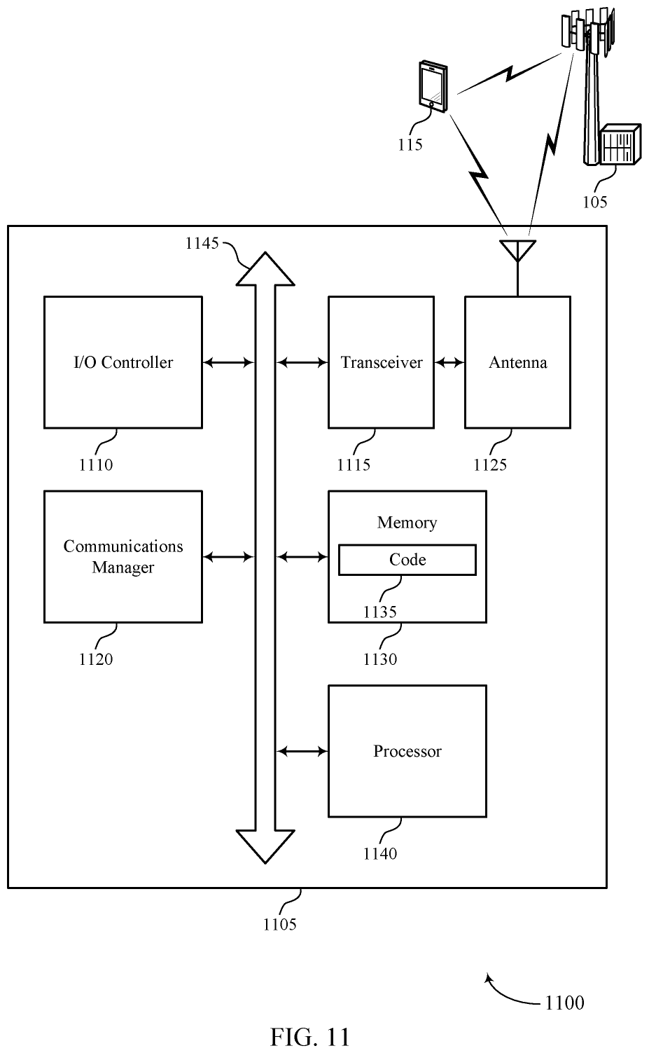

FIG. 11 illustrates a diagram of a system 1100 including a device 1105 that supports wideband sidelink synchronization signal block in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting wideband sidelink synchronization signal block) . For example, the device 1105 or a component of the device 1105 may include a processor 1140 and memory 1130 coupled with or to the processor 1140, the processor 1140 and memory 1130 configured to perform various functions described herein.

Additionally, or alternatively, the communications manager 1120 may support wireless communications at a first UE in accordance with examples as disclosed herein. For example, the communications manager 1120 may be configured as or otherwise support a means for generating a first portion of a sidelink control message, where the first portion of the sidelink control message includes a primary synchronization signal and a secondary synchronization signal occupying a first subset of a bandwidth of the sidelink control message. The communications manager 1120 may be configured as or otherwise support a means for generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. The communications manager 1120 may be configured as or otherwise support a means for transmitting the sidelink control message to a second UE.

Additionally, or alternatively, the communications manager 1120 may support wireless communications at a second UE in accordance with examples as disclosed herein. For example, the communications manager 1120 may be configured as or otherwise support a means for decoding a first portion of a sidelink control message, the first portion of the sidelink control message including a primary synchronization signal and a secondary synchronization signal that occupy a first subset of a bandwidth of the sidelink control message. The communications manager 1120 may be configured as or otherwise support a means for where the sidelink control message further including a second portion of the sidelink control message that occupies a second subset of the bandwidth of the sidelink control message such that the bandwidth of the sidelink control message satisfies an occupied channel bandwidth threshold, the second portion of the sidelink control message including additional control or data information that is encoded such that the first portion is decoded independent of a successful decoding of the second portion.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of wideband sidelink synchronization signal block as described herein, or the processor 1140 and the memory 1130 may be otherwise configured to perform or support such operations.

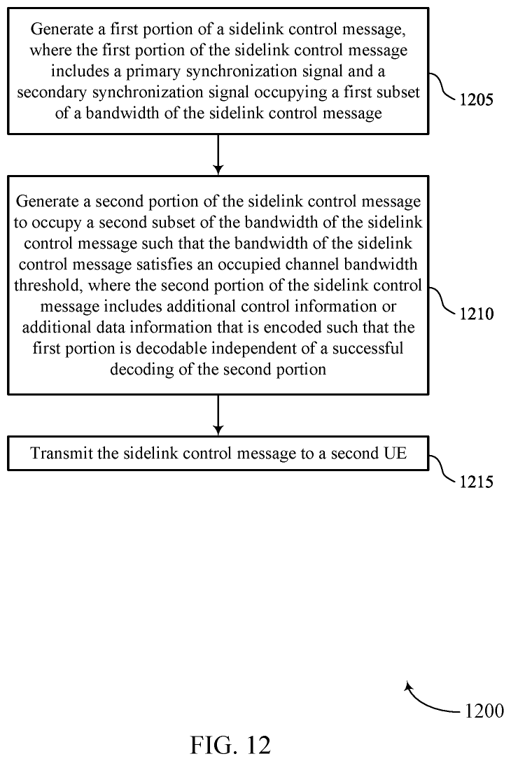

FIG. 12 illustrates a flowchart illustrating a method 1200 that supports the use of a wideband sidelink synchronization signal block in accordance with one or more examples as disclosed herein. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include generating a first portion of a sidelink control message, where the first portion of the sidelink control message includes a primary synchronization signal and a secondary synchronization signal occupying a first subset of a bandwidth of the sidelink control message. The operations of 1205 may be performed in accordance with examples as disclosed herein. In some examples, aspects of the operations of 1205 may be performed by a first portion component 1025 as described with reference to FIG. 10.

At 1210, the method may include generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. The operations of 1210 may be performed in accordance with examples as disclosed herein. In some examples, aspects of the operations of 1210 may be performed by a second portion component 1030 as described with reference to FIG. 10.

At 1215, the method may include transmitting the sidelink control message to a second UE. The operations of 1215 may be performed in accordance with examples as disclosed herein. In some examples, aspects of the operations of 1215 may be performed by a control message transmission component 1035 as described with reference to FIG. 10.

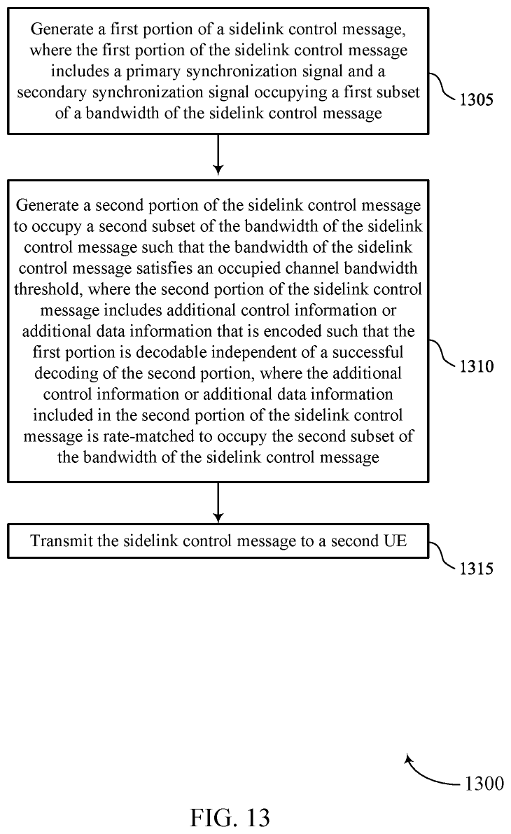

FIG. 13 illustrates a flowchart illustrating a method 1300 that supports the use of a wideband sidelink synchronization signal block in accordance with one or more examples as disclosed herein. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include generating a first portion of a sidelink control message, where the first portion of the sidelink control message includes a primary synchronization signal and a secondary synchronization signal occupying a first subset of a bandwidth of the sidelink control message. The operations of 1305 may be performed in accordance with examples as disclosed herein. In some examples, aspects of the operations of 1305 may be performed by a first portion component 1025 as described with reference to FIG. 10.

At 1310, the method may include generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. In some examples, the additional control information or additional data information included in the second portion of the sidelink control message is rate-matched to occupy the second subset of the bandwidth of the sidelink control message. The operations of 1310 may be performed in accordance with examples as disclosed herein. In some examples, aspects of the operations of 1310 may be performed by a second portion component 1030 as described with reference to FIG. 10. In some examples, aspects of the operations of 1310 may be performed by a rate matching component 1040 as described with reference to FIG. 10.

At 1315, the method may include transmitting the sidelink control message to a second UE. The operations of 1315 may be performed in accordance with examples as disclosed herein. In some examples, aspects of the operations of 1315 may be performed by a control message transmission component 1035 as described with reference to FIG. 10.

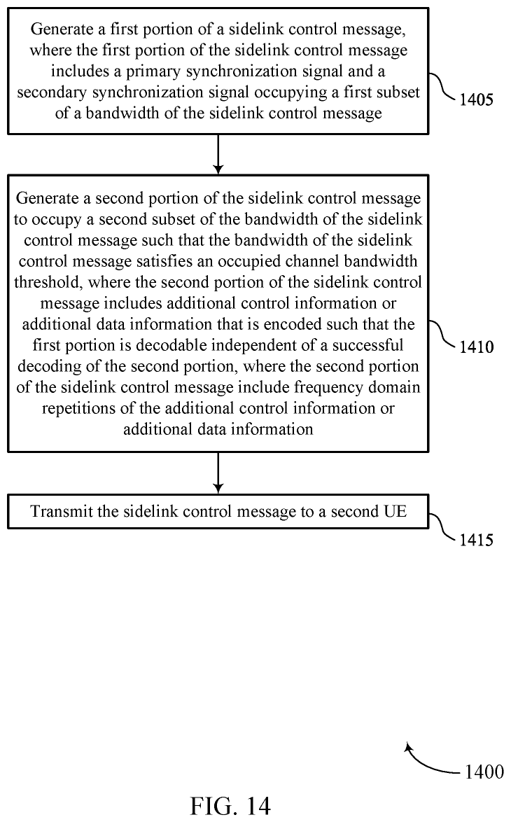

FIG. 14 illustrates a flowchart illustrating a method 1400 that supports the use of a wideband sidelink synchronization signal block in accordance with one or more examples as disclosed herein. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include generating a first portion of a sidelink control message, where the first portion of the sidelink control message includes a primary synchronization signal and a secondary synchronization signal occupying a first subset of a bandwidth of the sidelink control message. The operations of 1405 may be performed in accordance with examples as disclosed herein. In some examples, aspects of the operations of 1405 may be performed by a first portion component 1025 as described with reference to FIG. 10.

At 1410, the method may include generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. In some examples, the second portion of the sidelink control message includes frequency domain repetitions of the additional control information or additional data information. The operations of 1410 may be performed in accordance with examples as disclosed herein. In some examples, aspects of the operations of 1410 may be performed by a second portion component 1030 as described with reference to FIG. 10. In some examples, aspects of the operations of 1410 may be performed by a repetition component 1045 as described with reference to FIG. 10.

At 1415, the method may include transmitting the sidelink control message to a second UE. The operations of 1415 may be performed in accordance with examples as disclosed herein. In some examples, aspects of the operations of 1415 may be performed by a control message transmission component 1035 as described with reference to FIG. 10.

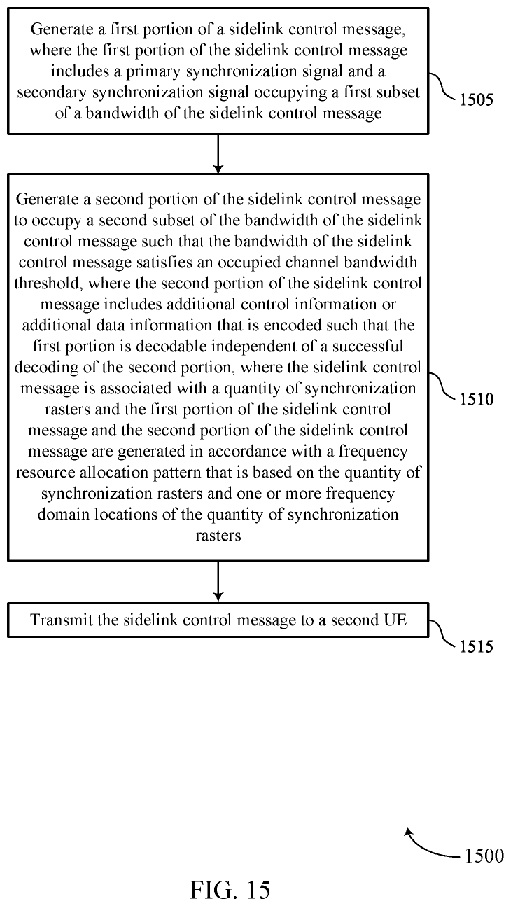

FIG. 15 illustrates a flowchart illustrating a method 1500 that supports the use of a wideband sidelink synchronization signal block in accordance with one or more examples as disclosed herein. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include generating a first portion of a sidelink control message, where the first portion of the sidelink control message includes a primary synchronization signal and a secondary synchronization signal occupying a first subset of a bandwidth of the sidelink control message. The operations of 1505 may be performed in accordance with examples as disclosed herein. In some examples, aspects of the operations of 1505 may be performed by a first portion component 1025 as described with reference to FIG. 10.

At 1510, the method may include generating a second portion of the sidelink control message to occupy a second subset of the bandwidth of the sidelink control message such that the bandwidth of the sidelink control message satisfies an occupied channel bandwidth threshold, where the second portion of the sidelink control message includes additional control information or additional data information that is encoded such that the first portion is decodable independent of a successful decoding of the second portion. In some examples, the sidelink control message being associated with a quantity of synchronization rasters. In some examples, the first portion of the sidelink control message and the second portion of the sidelink control message being generated in accordance with a frequency resource allocation pattern that is based on the quantity of synchronization rasters and one or more frequency domain locations of the quantity of synchronization rasters. The operations of 1510 may be performed in accordance with examples as disclosed herein. In some examples, aspects of the operations of 1510 may be performed by a second portion component 1030 as described with reference to FIG. 10. In some examples, aspects of the operations of 1510 may be performed by a synchronization raster component 1050 as described with reference to FIG. 10. In some examples, aspects of the operations of 1510 may be performed by a resource allocation component 1055 as described with reference to FIG. 10.

At 1515, the method may include transmitting the sidelink control message to a second UE. The operations of 1515 may be performed in accordance with examples as disclosed herein. In some examples, aspects of the operations of 1515 may be performed by a control message transmission component 1035 as described with reference to FIG. 10.

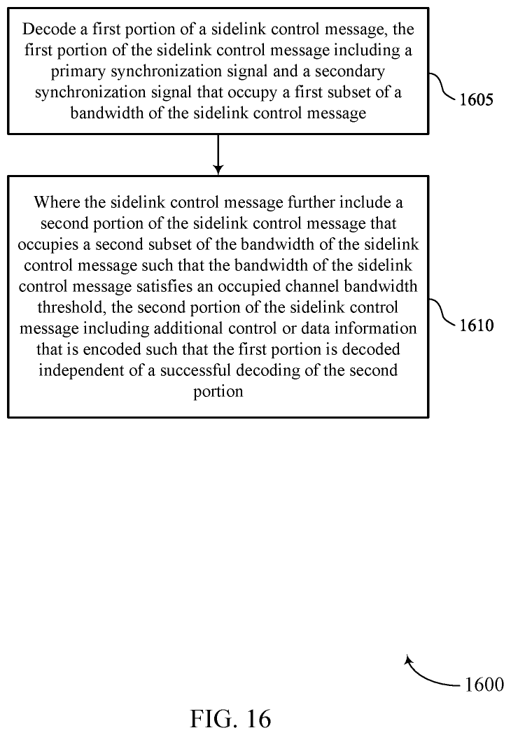

FIG. 16 illustrates a flowchart illustrating a method 1600 that supports the use of a wideband sidelink synchronization signal block in accordance with one or more examples as disclosed herein. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include decoding a first portion of a sidelink control message, the first portion of the sidelink control message including a primary synchronization signal and a secondary synchronization signal that occupy a first subset of a bandwidth of the sidelink control message. The operations of 1605 may be performed in accordance with examples as disclosed herein. In some examples, aspects of the operations of 1605 may be performed by a first portion component 1025 as described with reference to FIG. 10.

At 1610, the method may include where the sidelink control message further includes a second portion of the sidelink control message that occupies a second subset of the bandwidth of the sidelink control message such that the bandwidth of the sidelink control message satisfies an occupied channel bandwidth threshold, the second portion of the sidelink control message including additional control information or additional data information that is encoded such that the first portion is decoded independent of a successful decoding of the second portion. The operations of 1610 may be performed in accordance with examples as disclosed herein. In some examples, aspects of the operations of 1610 may be performed by a second portion component 1030 as described with reference to FIG. 10.

The following provides an overview of aspects of the present disclosure:

Aspect 1: A method for wireless communications at a first UE, comprising: generating a first portion of a sidelink control message, wherein the first portion of the sidelink control message comprises a primary synchronization signal and a secondary synchronization signal occupying a first subset of a bandwidth of the sidelink control message; generating a second portion of the sidelink control message to occupy a second subset of the bandwidth of the sidelink control message such that the bandwidth of the sidelink control message satisfies an occupied channel bandwidth threshold, wherein the second portion of the sidelink control message comprises additional control information or additional data information that is encoded such that the first portion is decodable independent of a successful decoding of the second portion; and transmitting the sidelink control message to a second UE.

Aspect 2: The method of aspect 1, wherein the additional control information or additional data information comprised in the second portion of the sidelink control message is rate-matched to occupy the second subset of the bandwidth of the sidelink control message.

Aspect 3: The method of aspect 2, wherein the additional control information or additional data information is rate-matched based at least in part on rate-matched control information comprised in the first portion of the sidelink control message.

Aspect 4: The method of any of aspects 2 through 3, wherein the additional control information or additional data information is rate-matched beginning with a lowest frequency resource of the second portion and a first time resource of the second portion of the sidelink control message.

Aspect 5: The method of any of aspects 2 through 4, wherein the additional control information or additional data information is rate-matched independently from rate-matched control information comprised in the first portion of the sidelink control message.

Aspect 6: The method of any of aspects 1 through 5, wherein the second portion of the sidelink control message comprises frequency domain repetitions of the additional control information or additional data information.

Aspect 7: The method of aspect 6, wherein the frequency domain repetitions are rate-matched to occupy time resources corresponding to symbols of the primary synchronization signal and the secondary synchronization signal.

Aspect 8: The method of any of aspects 6 through 7, wherein the frequency domain repetitions are rate-matched from a first symbol to a last symbol or in accordance with a rate-matching order of control information comprised in the first portion of the sidelink control message.

Aspect 9: The method of any of aspects 6 through 8, wherein each demodulation reference signal associated with a respective frequency domain repetition is based at least in part on different initialization values.

Aspect 10: The method of any of aspects 6 through 9, wherein the additional control information comprises sidelink broadcast channel signaling rate-matched in accordance with a first rate-matching pattern and one or more demodulation reference signals rate-matched in accordance with a second rate-matching pattern different than the first rate-matching pattern.

Aspect 11: The method of any of aspects 1 through 10, wherein the additional control information comprises sidelink control channel signaling, the additional data information comprises sidelink shared channel signaling, or both.

Aspect 12: The method of any of aspects 1 through 11, wherein the sidelink control message is associated with a quantity of synchronization rasters; and the first portion of the sidelink control message and the second portion of the sidelink control message are generated in accordance with a frequency resource allocation pattern that is based at least in part on the quantity of synchronization rasters and one or more frequency domain locations of the quantity of synchronization rasters.

Aspect 13: The method of aspect 12, wherein the frequency resource allocation pattern is based at least in part on a resource block offset associated with the first portion of the sidelink control message and a bandwidth of the second portion of the sidelink control message.

Aspect 14: The method of any of aspects 12 through 13, wherein the frequency resource allocation pattern is based at least in part on a quantity of resource blocks associated with the first portion of the sidelink control message, one or more gaps between the resource blocks, a block index associated with the first portion of the sidelink control message, or any combination thereof.

Aspect 15: The method of any of aspects 12 through 14, wherein the frequency resource allocation pattern is associated with a demodulation reference signal sequence associated with the first portion of the sidelink control message, a demodulation reference signal comb index, or both.

Aspect 16: The method of any of aspects 1 through 15, wherein the additional control information comprises sidelink broadcast channel signaling.

Aspect 17: A method for wireless communications at a second UE, comprising: decoding a first portion of a sidelink control message, the first portion of the sidelink control message comprising a primary synchronization signal and a secondary synchronization signal that occupy a first subset of a bandwidth of the sidelink control message; and wherein the sidelink control message further comprises a second portion of the sidelink control message that occupies a second subset of the bandwidth of the sidelink control message such that the bandwidth of the sidelink control message satisfies an occupied channel bandwidth threshold, the second portion of the sidelink control message comprising additional control or data information that is encoded such that the first portion is decoded independent of a successful decoding of the second portion.

Aspect 18: The method of aspect 17, wherein the additional control information or additional data information comprised in the second portion of the sidelink control message is rate-matched to occupy the second subset of the bandwidth of the sidelink control message.

Aspect 19: The method of aspect 18, wherein the additional control information or additional data information is rate-matched based at least in part on rate-matched control information comprised in the first portion of the sidelink control message.

Aspect 20: The method of any of aspects 18 through 19, wherein the additional control information or additional data information is rate-matched beginning with a lowest frequency resource of the second portion and a first time resource of the second portion of the sidelink control message.

Aspect 21: The method of any of aspects 18 through 20, wherein the additional control information or additional data information is rate-matched independently from rate-matched control information comprised in the first portion of the sidelink control message.

Aspect 22: The method of any of aspects 17 through 21, wherein the second portion of the sidelink control message comprises frequency domain repetitions of the additional control information or additional data information.

Aspect 23: The method of aspect 22, wherein the frequency domain repetitions are rate-matched to occupy time resources corresponding to symbols of the primary synchronization signal and the secondary synchronization signal.

Aspect 24: The method of any of aspects 22 through 23, wherein the frequency domain repetitions are rate-matched from a first symbol to a last symbol or in accordance with a rate-matching order of control information comprised in the first portion of the sidelink control message.

Aspect 25: The method of any of aspects 22 through 24, wherein each demodulation reference signal associated with a respective frequency domain repetition is based at least in part on different initialization values.

Aspect 26: The method of any of aspects 22 through 25, wherein the additional control information comprises sidelink broadcast channel signaling rate-matched in accordance with a first rate-matching pattern and one or more demodulation reference signals rate-matched in accordance with a second rate-matching pattern different than the first rate-matching pattern.

Aspect 27: The method of any of aspects 17 through 26, wherein the additional control information comprises sidelink control channel signaling, the additional data information comprises sidelink shared channel signaling, or both.

Aspect 28: The method of any of aspects 17 through 27, wherein the sidelink control message is associated with a quantity of synchronization rasters; and the first portion of the sidelink control message and the second portion of the sidelink control message are generated in accordance with a frequency resource allocation pattern that is based at least in part on the quantity of synchronization rasters and one or more frequency domain locations of the quantity of synchronization rasters.

Aspect 29: The method of aspect 28, wherein the frequency resource allocation pattern is based at least in part on a resource block offset associated with the first portion of the sidelink control message and a bandwidth of the second portion of the sidelink control message.

Aspect 30: The method of any of aspects 28 through 29, wherein the frequency resource allocation pattern is based at least in part on a quantity of resource blocks associated with the first portion of the sidelink control message, one or more gaps between the resource blocks, a block index associated with the first portion of the sidelink control message, or any combination thereof.

Aspect 31: The method of any of aspects 28 through 30, wherein the frequency resource allocation pattern is associated with a demodulation reference signal sequence associated with the first portion of the sidelink control message, a demodulation reference signal comb index, or both.

Aspect 32: The method of any of aspects 17 through 31, wherein the additional control information comprises sidelink broadcast channel signaling.

Aspect 33: An apparatus for wireless communications at a first UE, comprising a processor; memory coupled with the processor; and instructions stored in the memory and executable by the processor to cause the apparatus to perform a method of any of aspects 1 through 16.

Aspect 34: An apparatus for wireless communications at a first UE, comprising at least one means for performing a method of any of aspects 1 through 16.

Aspect 35: A non-transitory computer-readable medium storing code for wireless communications at a first UE, the code comprising instructions executable by a processor to perform a method of any of aspects 1 through 16.

Aspect 36: An apparatus for wireless communications at a second UE, comprising a processor; memory coupled with the processor; and instructions stored in the memory and executable by the processor to cause the apparatus to perform a method of any of aspects 17 through 32.

Aspect 37: An apparatus for wireless communications at a second UE, comprising at least one means for performing a method of any of aspects 17 through 32.

Aspect 38: A non-transitory computer-readable medium storing code for wireless communications at a second UE, the code comprising instructions executable by a processor to perform a method of any of aspects 17 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first user equipment (UE), comprising:
a processor:
memory coupled with the processor; and
instructions stored in the memory′ and executable by the processor to cause the apparatus to:
generate a first portion of a sidelink control message, wherein the first portion of the sidelink control message comprises a primary synchronization signal and a secondary synchronization signal occupying a first subset of a bandwidth of the sidelink control message;
generate a second portion of the sidelink control message to occupy a second subset of the bandwidth of the sidelink control message such that the bandwidth of the sidelink control message satisfies an occupied channel bandwidth threshold, wherein the second portion of the sidelink control message comprises additional control information or additional data information that is encoded such that the first portion is decodable independent of a successful decoding of the second portion; and
transmit the sidelink control message to a second UE.

2. The apparatus of claim 1, wherein the additional control information or additional data information comprised in the second portion of the sidelink control message is rate-matched to occupy the second subset of the bandwidth of the sidelink control message.

3. The apparatus of claim 2, wherein the additional control information or additional data information is rate-matched based at least in part on rate-matched control information comprised in the first portion of the sidelink control message.

4. The apparatus of claim 2, wherein the additional control information or additional data information is rate-matched beginning with a lowest frequency resource of the second portion and a first time resource of the second portion of the sidelink control message.

5. The apparatus of claim 2, wherein the additional control information or additional data information is rate-matched independently from rate-matched control information comprised in the first portion of the sidelink control message.

6. The apparatus of claim 1, wherein the second portion of the sidelink control message comprises frequency domain repetitions of the additional control information or additional data information.

7. The apparatus of claim 6, wherein the frequency domain repetitions are rate-matched to occupy time resources corresponding to symbols of the primary synchronization signal and the secondary synchronization signal.

8. The apparatus of claim 6, wherein the frequency domain repetitions are rate-matched from a first symbol to a last symbol or in accordance with a rate-matching order of control information comprised in the first portion of the sidelink control message.

9. (canceled)

10. The apparatus of claim 6, wherein the additional control information comprises sidelink broadcast channel signaling rate-matched in accordance with a first rate-matching pattern and one or more demodulation reference signals rate-matched in accordance with a second rate-matching pattern different than the first ratematching pattern.

11. The apparatus of claim 1, wherein the additional control information comprises sidelink control channel signaling, the additional data information comprises sidelink shared channel signaling, or both.

12. The apparatus of claim 1, wherein:
the sidelink control message is associated with a quantity of synchronization rasters; and
the first portion of the sidelink control message and the second portion of the sidelink control message are generated in accordance with a frequency resource allocation pattern that is based at least in part on the quantity of synchronization rasters and one or more frequency domain locations of the quantity of synchronization rasters.

13-16. (canceled)

17. An apparatus for wireless communications at a second user equipment (UE), comprising:
a processor;
memory coupled with the processor; and
instructions stored in the memory′ and executable by the processor to cause the apparatus to:
decode a first portion of a sidelink control message, the first portion of the sidelink control message comprising a primary synchronization signal and a secondary synchronization signal that occupy a first subset of a bandwidth of the sidelink control message;
wherein the sidelink control message further comprise a second portion of the sidelink control message that occupies a second subset of the bandwidth of the sidelink control message such that the bandwidth of the sidelink control message satisfies an occupied channel bandwidth threshold, the second portion of the sidelink control message comprising additional control information or additional data information that is encoded such that the first portion is decoded independent of a successful decoding of the second portion.

18. The apparatus of claim 17, wherein the additional control information or additional data information comprised in the second portion of the sidelink control message is rate-matched to occupy the second subset of the bandwidth of the sidelink control message.

19. The apparatus of claim 18, wherein the additional control information or additional data information is rate-matched based at least in part on rate-matched control information comprised in the first portion of the sidelink control message.

20. The apparatus of claim 18, wherein the additional control information or additional data information is rate-matched beginning with a lowest frequency resource of the second portion and a first time resource of the second portion of the sidelink control message.

21. The apparatus of claim 17, wherein the second portion of the sidelink control message comprises frequency domain repetitions of the additional control information or additional data information.

22. The apparatus of claim 21, wherein the frequency domain repetitions are rate-matched to occupy time resources corresponding to symbols of the primary′ synchronization signal and the secondary synchronization signal.

23. The apparatus of claim 21, wherein the frequency domain repetitions are rate-matched from a first symbol to a last symbol or in accordance with a rate-matching order of control information comprised in the first portion of the sidelink control message.

24. (canceled)

25. The apparatus of claim 17, wherein the additional control information comprises sidelink control channel signaling, the additional data information comprises sidelink shared channel signaling, or both.

26-28. (canceled)

29. A method for wireless communications at a first user equipment (UE), comprising:
generating a first portion of a sidelink control message, wherein the first portion of the sidelink control message comprises a primary synchronization signal and a secondary synchronization signal occupying a first subset of a bandwidth of the sidelink control message;
generating a second portion of the sidelink control message to occupy a second subset of the bandwidth of the sidelink control message such that the bandwidth of the sidelink control message satisfies an occupied channel bandwidth threshold, wherein the second portion of the sidelink control message comprises additional control information or additional data information that is encoded such that the first portion is decodable independent of a successful decoding of the second portion; and transmitting the sidelink control message to a second UE.

30. (canceled)
